(19) United States
(12) Patent Application Publication
(10) Pub. No.: US 2017/0149477 A1
(43) Pub. Date: May 25, 2017

(54) ANTENNA MULTIPLEXING METHOD AND MOBILE TERMINAL

(71) Applicants: LE HOLDINGS (BEIJING) CO., LTD., Beijing (CN); Lemobile Information Technology (Beijing) Co., Ltd, Beijing (CN)

(72) Inventor: Decai ZHU, Beijing (CN)

(21) Appl. No.: 15/249,256

(22) Filed: Aug. 26, 2016

Related U.S. Application Data
(63) Continuation of application No. PCT/CN2016/087610, filed on Jun. 29, 2016.

(30) Foreign Application Priority Data
Nov. 20, 2015 (CN) 201510812996.0

(51) Int. Cl. H04B 7/04; H04W 16/14; H04W 48/18; H04B 7/06

(52) U.S. Cl. CPC H04B 7/0404; H04B 7/0413; H04B 7/0686; H04W 16/14; H04W 48/18; H04W 84/12

(57) ABSTRACT

An embodiment of the present disclosure discloses an antenna multiplexing method and a mobile terminal when receiving data through a WLAN antenna, a mobile terminal closes cellular network communication, selects and multiplexes the cellular antenna into a WLAN diversity antenna when the correlation of the WLAN antenna in the working frequency band with the cellular antenna meets 2*2MIMO networking configuration requirements, thus increasing the quantity of the WLAN antennas, achieving dual-antenna configuration, realizing multiplying of the output, and improving user experience.

### CROSS-REFERENCE TO RELATED APPLICATIONS

The present disclosure is a continuation of International Application No. PCT/CN2016/087610 filed on Jun. 29, 2016, which is based upon and claims priority to Chinese Patent Application No. 201510812996.0, entitled “WIRELESS LOCAL NETWORK MIMO DIVERSITY ANTENNA MULTIPLEXING CELL METHOD AND MOBILE TERMINAL”, filed on Nov. 20. 2015, the entire contents of all of which are incorporated herein by reference.

### TECHNICAL FIELD

The present disclosure generally relates to the antenna multiplexing field, in particular to an antenna multiplexing method and a mobile terminal.

### BACKGROUND

At present, mainstream mobile terminals, for example mobile phones, PDA, etc., generally provide WLAN (Wireless Local Area Networks) and cellular data services. In order to enhance the data output of mobile terminals, hardware platforms usually supply dual-antenna implementation solutions. For the cellular antenna technology, diversity antenna technology has covered various 2G/3G/4G systems. On the one hand, diversity receiving gains are supplied. On the other hand, existing mobile terminals with metal housings are a popular trend, for example Qualcomm ASDiv (Antenna Switch Diversity) algorithm is applied to rapid deterioration of the performance of one antenna caused by operations such as manual hold, and used for overcoming the difficulty of “dead manual hold” antenna of the metal housing. For WLAN antenna technology, the use of the second antenna brings many benefits.

Mobile terminal products, such as mobile phones, are highly integrated electronic products. The demands on antenna quantity and frequency coverage greatly increase the difficulties in antenna development. Mutual backup and multiplexing technologies of antenna are continuously imported.

The last Qualcomm's antenna design solution is a cellular diversity antenna, which is a diversity antenna applicable to the WLAN (applicate to all three modes, namely applicable to 2.4 GHz only, applicable to 5 GHz only or applicable to both 2.2 GHz and 5 GHz) MIMO (Multiple-Input Multiple-Output) technology. The biggest advantage of this solution is maximization of the effect of the cellular diversity antenna, namely the cellular multiplexing antenna is multiplexed as the diversity of WLAN MIMO, so adding an independent antenna is not needed.

However, such solution has the following disadvantages:
the solution recommended by Qualcomm is a multi-band antenna solution. Actually, many companies of mobile terminals usually adopt, full-band antenna solution. Qualcomm's solution has requirements for the 2.4 GHz (and/or) 5 GHz performance of the cellular diversity solution, which greatly increasing difficulties in design of the full-band diversity antennas. During antenna development, if consideration cannot be given to the antenna performance the WLAN frequency band while ensuring the demands of the cellular frequency band, which means that when the cellular diversity antenna is used as the WLAN antenna, the poor is extremely poor.

Therefore, the technical problem urgently needed to be solved is to provide an antenna multiplexing method and a mobile terminal to realize a full-band antenna design solution.

### SUMMARY

An embodiment of the present disclosure discloses a method and a Mobile terminal for multiplexing a cellular antenna as a WLAN MIMO diversity antenna to overcome the defect of tailing to give consideration to the antenna performance of the WLAN frequency band while ensuring to meet the needs of the cellular frequency band in the prior art, realizing a full-band antenna design solution.

In order to solve the above problem, an embodiment of the present disclosure discloses a method for multiplexing the cellular antenna into a WLAN MIMO diversity antenna, including:
when a WLAN antenna receives data, a mobile terminal closing cellular network communication, selecting and multiplexing the cellular antenna into a WLAN diversity antenna when the correlation of the WLAN antenna in the working frequency band with the cellular antenna meets 2*2MIMO networking configuration requirements.

The method according to the embodiment of the present disclosure further includes:
multiplexing a cellular master antenna into WLAN diversity antenna only when the correlation of the WLAN antenna with the cellular master antenna meets the 2*2MIMO networking configuration requirements.

The method according to the embodiment of the present disclosure further includes:
multiplexing the cellular diversity antenna into the WLAN diversity antenna only when the correlation of the WLAN antenna with the cellular diversity antenna meets the 2*2MIMO networking configuration requirements.

The method according to the embodiment of the present disclosure further includes:
multiplexing a cellular antenna with a high antenna efficiency on the working frequency band of the current WLAN into the WLAN diversity antenna when the correlation of the WLAN antenna with the cellular diversity antenna and the correlation of the WLAN antenna with the cellular master antenna meet the 2*2MIMO networking configuration requirements at the same time.

According to the method of the embodiment of the present disclosure, the WLAN supports 2.4 GHz only, or supports 5 GHz only, or supports 2.4 GHz and 5 GHz at the same time.

In order to solve the above problem, an embodiment of the present disclosure discloses a mobile terminal for multiplexing the cellular antenna into a WLAN MIMO diversity antenna, including: a cellular master antenna module, a cellular diversity antenna module, a WLAN antenna module, and also including:
a WLAN diversity antenna multiplexing processing module, used for, when a WLAN antenna module receives data, closing cellular network communication, selecting and multiplexing the cellular antenna into a WLAN diversity antenna when the correlation of the WLAN antenna in the working frequency band with the cellular antenna meets 2*2MIMO networking configuration requirements.

According to the mobile terminal provided by the embodiment of the present disclosure, wherein, the WLAN diversity antenna multiplexing processing module further includes:
an antenna selection unit for determining the correlations of the WLAN antenna on the working frequency band respectively with the cellular master antenna and cellular diversity antenna, and selecting the cellular antenna meeting the 2*2MIMO networking configuration requirements;
and an antenna switching unit for switching and multiplexing the cellular antenna determined by the antenna selection unit into the WLAN diversity antenna.

According to the mobile terminal of the present disclosure, wherein, the switching unit includes two double-pole-double-throw switches that are respectively connected with the cellular master antenna module and the cellular diversity antenna module.

According to the mobile terminal of the present disclosure, wherein, the WLAN diversity antenna multiplexing processing module is Ruttier used for multiplexing a cellular antenna with a high antenna efficiency on the working frequency band of the current WLAN into the WLAN diversity antenna when the correlation of the WLAN antenna with the cellular diversity antenna and the correlation of the WLAN antenna with the cellular master antenna meet the 2*2MIMO networking configuration requirements at the same time,

According to the mobile terminal of the embodiment of the present disclosure, wherein the WLAN antenna module supports 2.4 GHz only, or supports 5 GHz only, or supports 2.4 GHz and 5 GHz at the same time.

An embodiment of the present disclosure provides a computing device, including one or more processors; a memory communicably connected with the at least one processor for storing instructions executable by the at least one processor, wherein execution of the instructions by the at least one processor causes the at least one processor to: when receiving data through the WLAN antenna, close cellular network communication, select and multiplex the cellular antenna into a WLAN diversity antenna when the correlation of the WLAN antenna in the working frequency band with the cellular antenna meets 2*2MIMO networking configuration requirements.

An embodiment of the present disclosure provides a computer readable storage medium recorded with programs for executing the method according to the embodiment of the present disclosure.

The embodiment of the present disclosure provides the method and mobile terminal for multiplexing the cellular antenna into the WLAN MIMO diversity antenna. When the data received by the WLAN antenna shows that diversity gain is needed, the mobile terminal determines the correlations of the cellular master antenna and the cellular diversity antenna with the WLAN diversity antenna respectively, and select the cellular antenna with a low correlation as the WLAN diversity antenna, increasing the quantity of WLAN antennas. Due to increase of the WLAN antenna in quantity, dual antenna configuration is obtained, the output is multiplied, and user experience is improved.

### BRIEF DESCRIPTION OF THE DRAWINGS

To more clearly describe the technical solution in the embodiments of the present disclosure or in the prior art, the following is a brief introduction of the attached drawings used to describe the technology in the embodiments or in the prior art. Obviously, the attached drawings described below involve some embodiments of the present disclosure. For those originally skilled in this field, other drawings can be made according to those drawings without creative labor.

FIG. 1 is a step flowchart of a method for multiplexing a cellular antenna into a WLAN MIMO diversity antenna according to an embodiment of the present disclosure.

FIG. 2 is a structural block diagram of a mobile terminal for multiplexing a cellular antenna into a WLAN MIMO diversity antenna according to an embodiment of the present disclosure, which supports 2.4 GHz only.

FIG. 3 is a structural block diagram of a mobile terminal for multiplexing a cellular antenna into a WLAN MIMO diversity antenna according to an embodiment of the present disclosure, which supports 5 GHz only.

FIG. 4 is a structural block diagram of a mobile terminal for multiplexing a cellular antenna into a WLAN MIMO diversity antenna according to an embodiment of the present disclosure, which supports 2.4 GHz and 5 GHz at the same time,

FIG. 5 illustrates a block diagram of a computing device for executing the method according to the present disclosure.

FIG. 6 illustrates a memory cell for holding or carrying program codes for realizing the method according to the present disclosure.

### DESCRIPTION OF THE EMBODIMENTS

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, those ordinarily skilled in this field can obtain other embodiments without creative labor, which all shall fall within the protective, scope of the present disclosure.

### Embodiment 1

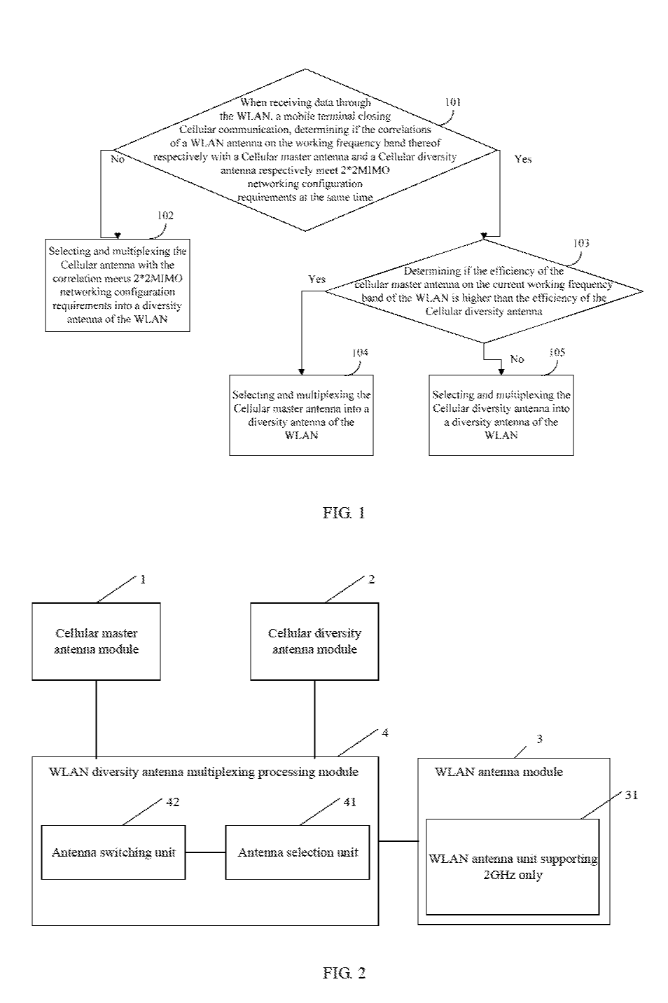

Refer to FIG. 1, which illustrates a step flowchart of a method for multiplexing a cellular antenna into a WLAN MIMO diversity antenna according to an embodiment of the present disclosure.

The method according to the embodiment of the present disclosure includes the following steps:
step 101: when receiving data through the WLAN a mobile terminal closing cellular communication, determining if the correlations of a WLAN antenna on the working frequency band thereof with a cellular master antenna and a cellular diversity antenna respectively meet 2*2MIMO networking configuration requirements at the same time; if so, executing step 103; and if not, executing step 102;
step 102: selecting and multiplexing the cellular antenna with the correlation meets 2*2MIMO networking configuration requirements into a diversity antenna of the WLAN, and ending;
step 103: determining if the efficiency of the cellular master antenna on the current working frequency band of the WLAN is higher than the efficiency of the cellular diversity antenna; if so, executing step 104; otherwise, executing step 105;

step 104: selecting and multiplexing the cellular master antenna into a diversity antenna of the WLAN, and ending.

step 105: selecting and multiplexing the cellular diversity antenna into a diversity antenna of the WLAN, and ending.

In this embodiment, when receiving data through a WLAN antenna, the mobile terminal closes cellular network communication, determines if the correlations of a WLAN antenna on the working frequency band thereof with a cellular master antenna and a cellular diversity antenna respectively meet 2*2MIMO networking configuration requirements at the same time, selects and multiplexes the cellular antenna with the correlation meets 2*2MIMO networking configuration requirements into a diversity antenna of the WLAN, thus increasing the quantity of WLAN antennas. Due to increase of the WLAN antenna in quantity, dual antenna configuration is obtained, the output is multiplied, and user experience is improved.

When the correlation of the WLAN antenna with the cellular master antenna and the correlation of the WLAN antenna with the cellular diversity antenna meet the 2*2MIMO networking configuration requirements at the same time, the mobile terminal selects a cellular antenna with a high antenna efficiency on the working frequency band of the current WLAN as the WLAN diversity antenna, thus further enhancing the data transmission efficiency of the WLAN.

### Embodiment 2

Refer to FIG. 2, which illustrates a structural block diagram of a mobile terminal for multiplexing a cellular antenna into a WLAN MIMO diversity antenna according to an embodiment of the present disclosure, which supports 2.4 GHz only.

The mobile terminal in this embodiment includes:
a cellular master antenna module 1, a cellular diversity antenna module 2, a WLAN antenna module 3 and a WLAN diversity antenna multiplexing processing module 4.

Wherein, the WLAN antenna module 3 includes a WLAN antenna unit 31 which supports 2.4 GHz only.

The WLAN diversity antenna multiplexing processing module 4 also includes an antenna selection unit 41 and an antenna switching unit 42.

When the WLAN antenna unit 31 which supports 2.4 GHz only receives data, the cellular communication is closed. In the WLAN diversity antenna multiplexing processing module 4, the antenna selection unit 41 determines if the correlations of the WLAN antenna on the working frequency band with the cellular master antenna and the cellular diversity antenna respectively the 2*2MIMO networking configuration requirements, and selects the cellular antenna with the correlation meeting the 2*2MIMO networking configuration requirements. The antenna switching unit 42 is used for switching and multiplexing the cellular antenna determined by the antenna selection unit into the WLAN diversity antenna. Here, the antenna switching unit 42 can be two double-pole-double-throw switches which are respectively connected with the cellular master antenna module 1 and the cellular diversity antenna module 2. The two double-pole-double-throw switches complete the switching between the cellular master antenna module and the cellular diversity antenna module to realize the multiplexing of the WLAN diversity antenna. From the above process, it is seen that, the quantity of WLAN antennas increases. The increase in the quantity of the WLAN antennas achieves dual-antenna configuration, realizes multiple output, and improves user experience.

Here, when determining that the correlations of the WLAN antenna on the working frequency band thereof respectively with the cellular master antenna and the cellular diversity antenna meet the 2*2MIMO networking configuration requirements at the same time, the antenna selection unit 41 selects a cellular antenna with a high antenna efficiency on the working frequency band of the current WLAN, and the switching unit 42 multiplexes the cellular antenna with a high antenna switching efficiency into a WLAN diversity antenna. In this way, the data transmission efficiency of the WLAN is further enhanced.

### Embodiment 3

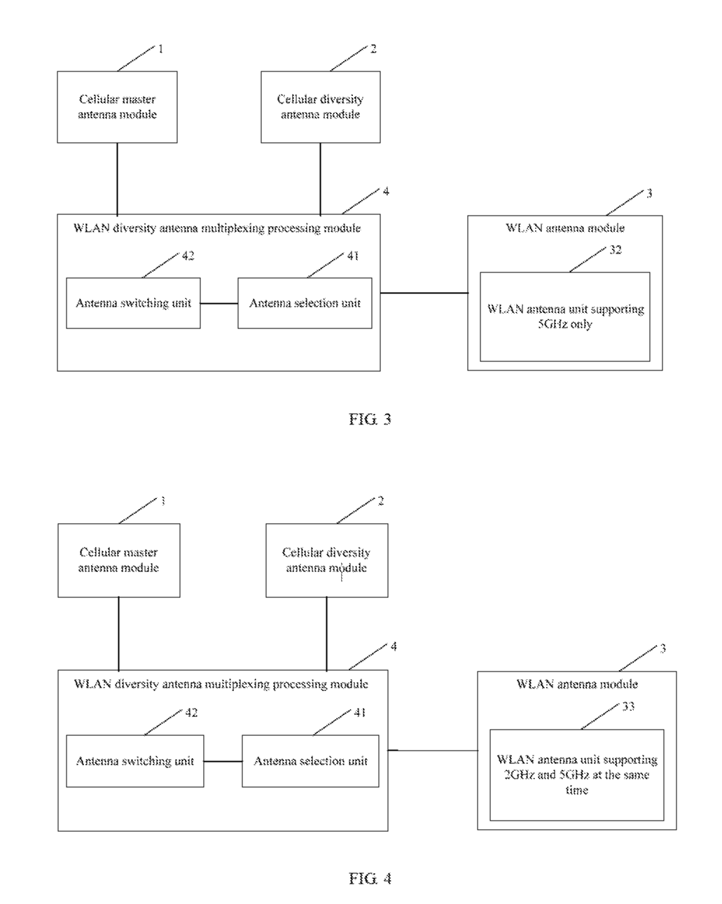

Refer to FIG. 3 which illustrates a structural block diagram of a mobile terminal for multiplexing a cellular antenna into a WLAN MIMO diversity antenna according to the third embodiment of the present disclosure, which supports 5 GHz only.

The mobile terminal in this embodiment includes:
a cellular master antenna module 1, a cellular diversity antenna module 2, a WLAN antenna module 3 and a WLAN diversity antenna multiplexing processing module 4.

Wherein, the WLAN antenna module 3 includes a WLAN antenna unit 32 which supports 5 GHz only.

The WLAN diversity antenna multiplexing processing module 4 also includes an antenna selection unit 41 and an antenna switching unit 42.

When the WLAN antenna unit 32 which supports 5 GHz only receives data, the cellular communication is closed. In the WLAN diversity antenna multiplexing processing module 4 the antenna selection module 41 determines if the correlations of the WLAN antenna on the working frequency band respectively with the cellular master antenna and the cellular diversity antenna meet the 2*2MIMO networking configuration requirements, and selects the cellular antenna with the correlation meeting the 2*2MIMO networking configuration requirements. The antenna switching unit 42 is used for switching and multiplexing the cellular antenna determined by the antenna selection unit into the WLAN diversity antenna. Here, the antenna switching unit 42 can be two double-pole-double-throw switches which are respectively connected with the cellular master antenna module 1 and the cellular diversity antenna module 2. The two double-pole-double-throw switches complete the switching between the cellular master antenna module and the cellular diversity antenna module to realize the multiplexing of the WLAN diversity antenna. From the above process, it is seen that, the quantity of WLAN antennas increases. The increase in the quantity of the WLAN antennas achieves dual-antenna configuration, realizes multiple output, and improves user experience.

Here, when determining that the correlations of the WLAN antenna on the working frequency band thereof respectively with the cellular master antenna and the cellular diversity antenna meet the 2*2MIMO networking configuration requirements at the same time, the antenna selection unit 41 selects a cellular antenna with a high antenna efficiency on the working frequency band of the current WLAN, and the switching unit 42 multiplexes the cellular antenna with a high antenna switching efficiency into a WLAN diversity antenna. In this way, the data transmission efficiency of the WLAN is further enhanced.

### Embodiment 4

Refer to FIG. 4, which illustrates a structural block diagram of a mobile terminal for multiplexing a cellular antenna into a WLAN MIMO diversity antenna according to the fourth embodiment of the present disclosure, which supports 2.4 GHz and 5 GHz at the same time.

The mobile terminal in this embodiment includes:
a cellular master antenna module 1, a cellular diversity antenna module 2 a WLAN antenna module 3 and a WLAN diversity antenna multiplexing processing module 4.

Wherein, the WLAN antenna module 3 includes a WLAN antenna unit 33 which supports 2.4 GHz and 5 GHz at the same time.

The WLAN diversity antenna multiplexing processing module 4 also includes an antenna selection unit 41 and an antenna switching unit 42.

When the WLAN antenna unit 33 which supports 2.4 GHz and 5 GHz at the same time receives data, the cellular communication is closed. In the WLAN diversity antenna multiplexing processing module 4, the antenna selection unit 41 determines if the correlations of the WLAN antenna on the working frequency band respectively with the cellular master antenna and the cellular diversity antenna meet the 2*2MIMO networking configuration requirements, and selects the cellular antenna with the correlation meeting the 2*2MIMO networking configuration requirements. The antenna switching unit 42 is used for switching and multiplexing the cellular antenna determined by the antenna selection unit into the WLAN diversity antenna. Here, the antenna switching unit 42 can be two double-pole-double-throw switches which are respectively connected with the cellular master antenna module 1 and the cellular diversity antenna module 2. The two double-pole-double-throw switches complete the switching between the cellular master antenna module and the cellular diversity antenna module to realize the multiplexing of the WLAN diversity antenna. From the above process, it is seen that, the quantity of WLAN antennas increases. The increase in the quantity of the WLAN antennas achieves dual-antenna configuration, realizes multiple output, and improves user experience.

Here, when determining that the correlations of the WLAN antenna on the working frequency band thereof respectively with the cellular master antenna and the cellular diversity antenna meet the 2*2MIMO networking configuration requirements at the same time, the antenna selection unit 41 selects a cellular antenna with a high antenna efficiency on the working frequency band of the current WLAN and the switching unit 42 multiplexes the cellular antenna with a high antenna switching efficiency into a WLAN diversity antenna. In this way, the data transmission efficiency of the WLAN is further enhanced.

The terminal device for multiplexing the cellular antenna into the WLAN MIMO diversity antenna in this embodiment is used for implementing the corresponding method for multiplexing the cellular antenna into the WLAN MIMO diversity antenna in the above-mentioned embodiment, and has beneficial effects of the corresponding method embodiments, beneficial effects not being repeatedly described here.

The device embodiment described above is schematic, wherein units described as separable parts may be or may be not physically separated, and components displayed as units may be or may be not physical units, which means that the units can be positioned at one place or distributed on a plurality of network units. Some or all modules can be selected to fulfill the objective of the solution in the embodiment upon actual demands. Those ordinarily skilled in this field can understand and implement the present disclosure without creative work.

The device embodiments of the present disclosure can be hardware, or software modules operating on one or more processors, or combinations thereof. Those skilled in this field should understand that, in practice, a microprocessor or a digital signal processor (DSP) can be used to conduct some or all functions of some or all parts in the communication processing device according to the embodiments of the present disclosure. The present disclosure can also realize some or all device or equipment programs (for example, computer programs and computer program products) of methods described here. Such programs for realizing the present disclosure can be stored in computer readable media, or may be in forms with one or more signals. Such signals can be downloaded from the Internet, or supplied by carrier signals, or supplied in any other ways.

For example, the device of the present disclosure can be applied to a server. The server traditionally includes a processor and computer program products or computer readable media in form of memories. The memories can be electronic memories such as flash memories, EEPROM (electrically-erasable programmable ROM), EPROM, hard discs, or ROM. The memories have storage space for program codes for executing any steps of the above methods. For example, the storage space for program codes can include the program codes for respectively executing all steps of the above methods. The programs can be read from one or more computer program products or written into one or more computer program products. The computer program products include program code carriers such as hard discs, compact discs (CD), memory cards, or floppy discs. The computer program products are usually portable or fixed memory cells. The memory cells can have storage segments, storage space, etc. similar to the memories in the above-mentioned server. The program codes can be compressed in an appropriate way. Usually, a memory cell includes computer readable codes, namely code which can be read by the above-mentioned processor. When the codes run on the server, the server executes the steps of methods described above.

Those ordinarily skilled in this field understand that all or some steps of the above embodiments can be completed through hardware related to the program commands. The above-mentioned programs can be stored in a computer readable storage medium. In use, the programs execute the steps of the above-mentioned method embodiment while the above-mentioned storage medium can he various medium capable of storing program codes, such as ROM, RAM, magnetic discs or optical discs.

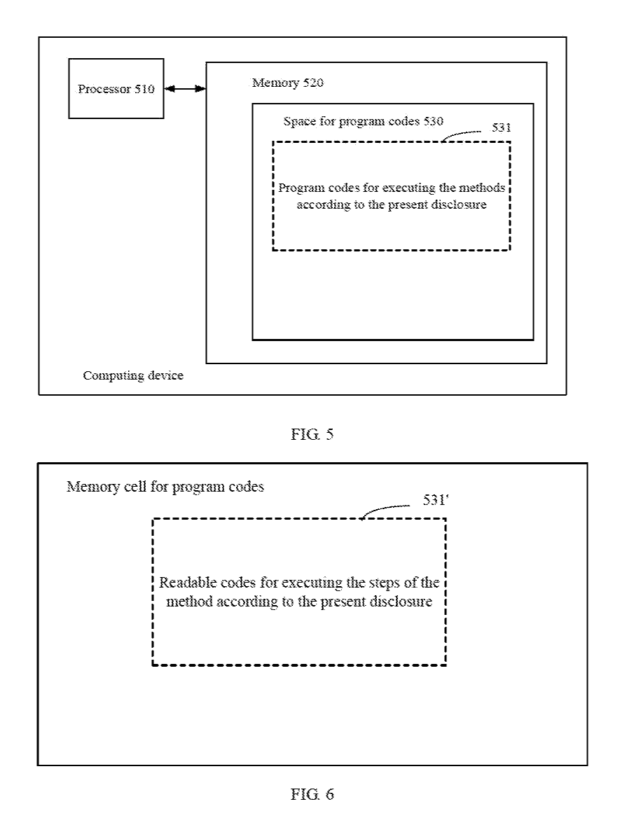

FIG. 5 illustrates a computing device for executing a video transcoding method according to the present disclosure. The computing device (for example a mobile terminal) traditionally includes a processor 510 and (program) products or medium in form of memories 520. The memories 520 can be electronic memories such as flash memories, EEPROM (electrically-erasable programmable ROM), EPROM or ROM. The memories 520 have storage space 530 for program codes 531 for executing any steps of the above methods. For example, the storage space 530 for program codes can include the program codes 531 for respectively executing all steps of the above methods. The programs can be read from one or more program products or written into one or more program products. The program products include program code carriers such as memory cards. Such program products are usually portable or fixed memory cells as shown in FIG. 6. The memory cells can have storage segments, storage space, etc. similar to the memories 520 in the computing device as shown in FIG. 5. The program codes can be compressed in a proper form. Usually, a memory=cell includes readable codes 531, namely code which can be read by a processor similar to the processor 510. When the codes run on the processor of the computing device, the process of the computing device executes the steps of methods described above.

Finally it should be noted that, the above embodiments are used to describe instead of limiting the technical solution of the present disclosure; although the above embodiments describe the present disclosure in detail, those ordinarily skilled in this field shall understand that they can modify the technical solutions in the above embodiments or make equivalent replacement on some or all technical characteristics of the present disclosure; those modifications or replacement and the corresponding technical solutions do not depart from the spirit and scope of the technical solutions of the above embodiments of the present disclosure.

What is claimed is:

1. A method for multiplexing a cellular antenna into a WLAN MIMO diversity antenna, comprising:
when a WLAN antenna receives data, a mobile terminal closing cellular network communication, selecting and multiplexing the cellular antenna into a WLAN diversity antenna when the correlation of the WLAN antenna in the working frequency band with the cellular antenna meets 2*2MIMO networking configuration requirements.

2. The method according to claim 1, further comprising:
multiplexing a cellular master antenna into a WLAN diversity antenna only when the correlation of the WLAN antenna with the cellular master antenna meets the 2*2MIMO networking configuration requirements.

3. The method according to claim 1, further comprising:
multiplexing the cellular diversity antenna into the WLAN diversity antenna only when the correlation of the WLAN antenna with the cellular diversity antenna meets the 2*2MIMO networking configuration requirements.

4. The method according to claim 1, further comprising:
multiplexing a cellular antenna with a high antenna efficiency on the working frequency band of the current WLAN into the WLAN diversity antenna when the correlation of the WLAN antenna with the cellular diversity antenna and the correlation of the WLAN antenna with the cellular master antenna meet the 2*2MIMO networking configuration requirements at the same time.

5. The method according to claim 1, wherein the WLAN supports 2.4 GHz only, or supports 5 GHz only, or supports 2.4 GHz and 5 GHz at the same time.

6. A mobile terminal for multiplexing a cellular antenna into a WLAN MIMO diversity antenna, comprising a cellular master antenna module, a cellular diversity antenna module, a WLAN antenna module, and further comprising:
a WLAN diversity antenna multiplexing processing module, used for, when a WLAN antenna module receives data, closing cellular network communication, selecting and multiplexing the cellular antenna into a WLAN diversity antenna when the correlation of the WLAN antenna in the working frequency band with the cellular antenna meets 2*2MIMO networking configuration requirements.

7. The mobile terminal according to claim 6, wherein the WLAN diversity antenna multiplexing processing module further comprises:
an antenna selection unit for determining the correlations of the WLAN antenna on the working frequency band respectively with the cellular master antenna and cellular diversity antenna, and selecting the cellular antenna meeting the 2*2MIMO networking configuration requirements;
and an antenna switching unit for switching and multiplexing the cellular antenna determined by the antenna selection unit into the WLAN diversity antenna.

8. The mobile terminal according to claim 6, wherein the switching unit comprises two double-pole-double-throw switches which are respectively connected with the cellular master antenna module and the cellular diversity antenna module.

9. The mobile terminal according to claim 6, wherein the WLAN diversity antenna multiplexing processing module is further used for multiplexing a cellular antenna with a high antenna efficiency on the working frequency band of the current local area network when the correlation of the WLAN antenna with the cellular diversity antenna and the correlation of the WLAN antenna with the cellular master antenna meet the 2*2MIMO networking configuration requirements at the same time.

10. The mobile terminal according to claim 6, wherein the WLAN antenna module supports 2.4 GHz only, or supports 5 GHz only, or supports 2.4 GHz and 5 GHz at the same time.

11. A computing device, comprising:
one or more processors;
a memory communicably connected with the at least one processor for storing instructions executable by the at least one processor, wherein execution of the instructions by the at least one processor causes the at least one processor to:
when the WLAN receives data, close cellular network communication, select and multiplex the cellular antenna into a WLAN diversity antenna when the correlation of the WLAN antenna in the working frequency band with the cellular antenna meets 2*2MIMO networking configuration requirements.

12. The computing device according to claim 11, wherein execution of the instructions by the at least one processor further causes the at least one processor to:
multiplex a cellular master antenna into a WLAN diversity antenna only when the correlation of the WLAN antenna with the cellular master antenna meets the 2*2MIMO networking configuration requirements.

13. The computing device according to claim 11, wherein execution of the instructions by the at least one processor further causes the at least one processor to:
multiplex the cellular diversity antenna into the WLAN diversity antenna only when the correlation of the WLAN antenna with the cellular diversity antenna meets the 2*2MIMO networking configuration requirements.

14. The computing device according to claim 11, wherein execution of the instructions by the at least one processor further causes the at least one processor to:
multiplex a cellular antenna with a high antenna efficiency on the working frequency band of the current WLAN into the WLAN diversity antenna when the correlation of the WLAN antenna with the cellular diversity antenna and the correlation of the WLAN antenna with the cellular master antenna meet the 2*2MIMO networking configuration requirements at the same time.

15. The computing device according to claim 11, wherein the WLAN supports 2.4 GHz only, or supports 5 GHz only, or supports 2.4 GHz and 5 GHz at the same time.
